(19) United States
(12) Patent Application Publication
(10) Pub. No.: US 2016/0110119 A1
(43) Pub. Date: Apr. 21, 2016

(54) DIRECT MEMORY ACCESS FOR COMMAND-BASED MEMORY DEVICE

(71) Applicants: Prabhjot Singh, Noida (IN); Nitin Gera, Delhi (IN); Hemant Nautiyal, Greater Noida (IN)

(72) Inventors: Prabhjot Singh, Noida (IN); Nitin Gera, Delhi (IN); Hemant Nautiyal, Greater Noida (IN)

(21) Appl. No.: 14/515,500

(22) Filed: Oct. 15, 2014

(51) Int. Cl. G06F 3/06; G06F 13/16; G06F 13/28

(52) U.S. Cl. CPC G06F 3/0613; G06F 3/0688; G06F 3/0659; G06F 13/28; G06F 13/1694; G06F 2206/1014

(57) ABSTRACT

In a processing system, an integrated function controller (IFC) for one or more memory devices, including a NAND flash memory device, provides direct memory access (DMA) functionality for writing data to and reading data from the NAND flash memory device, thereby reducing the level of CPU intervention required to support such operations. In one implementation, the CPU stores in system memory a descriptor-based DMA operation sequence of NAND flash operations and then triggers the IFC to implement the descriptor sequence. The IFC sequentially fetches and implements individual stored descriptors without interrupting the CPU or requiring any real-time CPU intervention using, for example, a “repeat while busy” polling descriptor type. The IFC frees up the CPU to perform other system-level operations, thereby increasing the efficiency of the processing system.

### BACKGROUND

The present invention relates to integrated circuits and, more particularly, to command-based memory devices such as NAND flash memory devices.

It is known to configure processing systems with multiple different types of memory, such as NOR flash memory, SRAM (static random access memory), FPGA (field-programmable gate array) memory, ASIC (application-specific integrated circuit) memory, and NAND flash memory. Since NOR flash, SRAM, FPGA, and ASIC memories are memory-mapped devices, they can be controlled using direct memory access (DMA) technology. NAND flash memories cannot be controlled using conventional DMA technology because they are indirectly mapped devices. In particular, NAND flash memory is a command-based device where a single, shared I/O bus is used to carry command, address, and data. NAND flash memory stores data in page format of size 512 bytes, 2 KB, 4 KB, 8 KB, etc. In conventional processing systems, CPU (central processing unit) intervention is performed after every page access to NAND flash memory.

As the density and speed of memory devices have significantly increased in recent years, there is a need to increase data-transfer efficiency in processing systems. Unfortunately, the conventional requirement of CPU intervention after each page access limits the data-transfer efficiency of NAND flash memory devices.

FIG. 1 is a schematic diagram of the hierarchical architecture of a conventional NAND flash memory device 100 having a hierarchical architecture. As represented in FIG. 1, the NAND flash memory device 100 has a number (e.g., three) of logical units (LUNs) 102. Each LUN 102 has a number (e.g., B+2) of blocks 104, and each block 104 has a number (e.g., P+1) of pages 106, and each page 106 has an array of memory cells (not shown) arranged in rows and columns.

In conventional NAND flash memory technology, only one LUN 102 can be accessed at a time. As such, before a subsequent page access can be performed, the previous page access must be completed.

Recent NAND flash memory devices support queries from external devices as to its busy versus available status. According to one type of query referred to as a Read Status Enhanced command, an external device queries the NAND flash memory device about the status of target LUN, and the NAND flash memory device responds with a one-bit response indicating whether it is busy (i.e., still handling a previous page access) or available (i.e., ready to handle a subsequent page access).

FIG. 1 shows an AND gate 112 that collects the different LUN status values 110 stored in a status register 108 of each LUN 102 and reports the device-level status 114 to the external world. If any LUN 102 is busy, such that at least one LUN status value 110 is equal to logic 0, then the device-level status value 114 will also be equal to logic 0 indicating that the NAND flash memory device 100 is busy. On the other hand, if all of the LUNs 102 are available, such that all LUN status values 110 are equal to logic 1, then the NAND flash memory device status value 114 will be equal to logic 1 indicating that the NAND flash memory device 100 is available for the next access.

FIG. 2 is a block diagram of a conventional processing system 200 configured with multiple memory devices such as the NAND flash memory device 100 of FIG. 1, NOR flash memory device 234, and SRAM, FPGA, or ASIC memory device 236. The processing system 200 also has CPU 202, system memory 204, and IFC (integrated function controller) 210, which communicate via a system bus 206, while the IFC 210 communicates with the various memory devices 100, 234, and 236 via a flash bus 230. The IFC 210 operates as the functional interface between the CPU 202 and the different memory devices 100, 234 and 236.

Programming registers 211 in the IFC 210 store instructions from the CPU 202. Because the NOR flash device 234 and the SRAM/FPGA/ASIC memory device 236 are memory-mapped devices, write data to be stored in the memory-mapped devices 236 can be moved from the system memory 204 to those devices via the system bus 206, system slave interface 212, the corresponding function control machine (FCM) (i.e., either NOR FCM 216 or general-purpose FCM 217), flash interface arbiter 218, and the flash bus 230 using conventional DMA data-write technology. Similarly, read data can be read from those memory-mapped devices to the system memory 204 in the opposite direction using conventional DMA data-read technology.

Because, however, the NAND flash memory device 100 is an indirectly mapped, command-based device, write data is copied from the system memory 204 into an SRAM buffer 213 of the IFC 210 before a NAND FCM 215 writes that data to the NAND flash memory device 100. Similarly, the NAND FCM 215 reads the read data from the NAND flash memory device 100 and stores that read data in the SRAM buffer 213 before it is copied to the system memory 204.

The IFC 210 also has BCH (Bose-Chaudhuri) ECC (error correction code) encoder/decoder 214 that can encode write data before it is written to the NAND flash memory device 100 and decode read data after it is read from the NAND flash memory device 100.

FIG. 3 is a flow chart of a sequence of operations of the conventional processing system 200 of FIG. 2 corresponding to two consecutive write operations to the NAND flash memory device 100.

In step 302, the CPU 202 programs the IFC registers 211 to send a Read Status Enhanced command to the NAND flash memory device 100 to determine whether the first target LUN of the NAND flash memory device 100 is available for a page access. In response, in step 304, the IFC 210 receives the status of the target LUN from the NAND flash memory device 100 and interrupts the CPU 202 with that status information.

In step 306, the CPU 202 determines whether or not the first target LUN is available. If not, then processing returns to steps 302 and 304 for the CPU 202 to re-program the IFC registers 211 to send another Read Status Enhanced command and for the NAND flash memory device 100 to provide another response as to the current status of the first target LUN. This process is repeated until the target LUN is finally available. At that time, processing continues to step 308.

In step 308, the CPU 202 stores the write data into the IFC SRAM 213, and, in step 310, the CPU 202 triggers a NAND Page Program Operation to write that data into the first target LUN of the NAND flash memory device 100. As indicated in step 312, the NAND flash memory device 100 enters a busy state, e.g., for a micro-seconds, while the data-write operation is being implemented.

In the meantime, even though the NAND flash memory device 100 is busy executing the data-write operation, in step 314, the CPU 202 programs the IFC registers 211 to send a Read Status Enhanced command to the second target LUN of the NAND flash memory device 100 to determine whether the NAND flash memory device 100 is available for the next page access. The processing of steps 314-322 for the second data-write operation is analogous to the previously described processing of steps 302-312 for the first data-write operation, with steps 314 and 316 having to be repeated until the NAND flash memory device 100 is available to handle the next page access.

According to this scenario, CPU intervention occurs after every access of the NAND flash memory device 100, including after each instance of the Read Status Enhanced command to check on the status of NAND flash memory device 100. This repeated CPU intervention limits the data-transfer efficiency of the NAND flash memory device 100 within the conventional processing system 200. Accordingly, it would be advantageous to have a more efficient method of accessing pages of a NAND flash memory.

### BRIEF DESCRIPTION OF THE DRAWINGS

Other embodiments of the invention will become more fully apparent from the following detailed description, the appended claims, and the accompanying drawings in which like reference numerals identify similar or identical elements.

FIG. 1 is a schematic diagram of the hierarchical architecture of a conventional NAND flash memory device;

FIG. 2 is a block diagram of a conventional processing system having multiple memory devices including the conventional NAND flash memory device of FIG. 1;

FIG. 3 is a flow chart of a sequence of operations of the conventional processing system of FIG. 2;

FIG. 4 is a block diagram of a processing system of the present invention having multiple memory devices including a NAND flash memory device;

FIG. 5 is a flow chart of an exemplary sequence of operations of the processing system of FIG. 4;

FIG. 6 shows a portion of the processing system of FIG. 4 representing the sequence of operations of FIG. 5;

FIG. 7 shows a tabular representation of the syntax of descriptors stored in the system memory of FIG. 4 according to one possible implementation of the present invention;

FIGS. 8A-8D (collectively referred to as FIG. 8) present a table defining the various descriptor fields shown in FIG. 7;

FIG. 9 shows a state diagram for the operations of the DMA controller of FIG. 4 according to one possible FSM (finite state machine) implementation of the present invention; and

FIG. 10 presents a table containing descriptions of the ten different state transitions shown in FIG. 9.

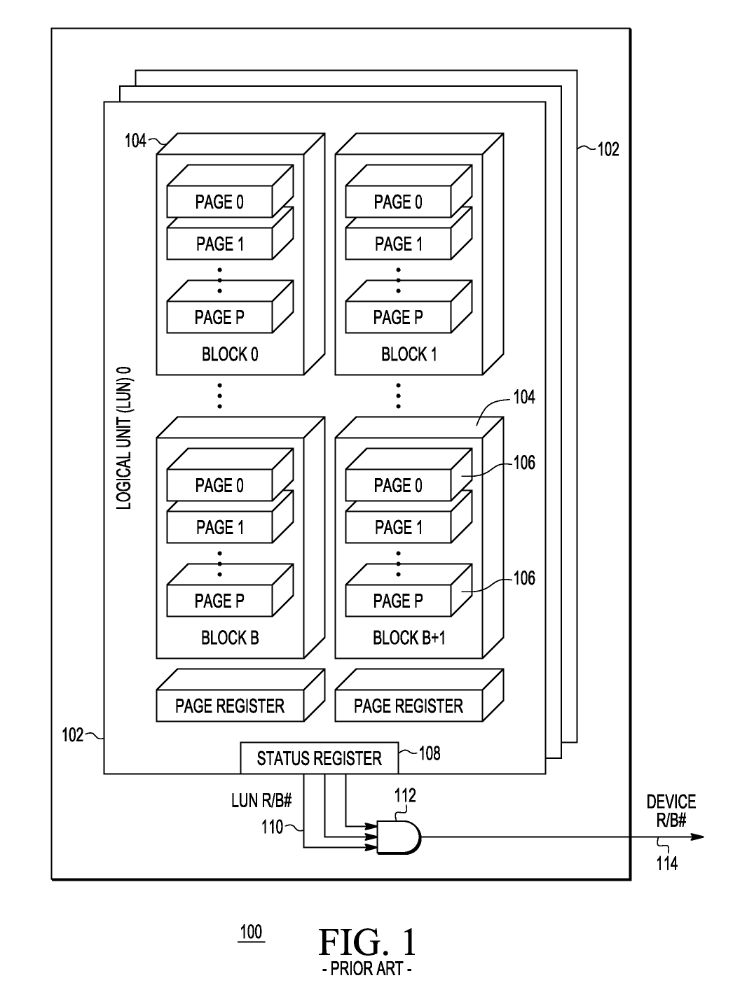

### DETAILED DESCRIPTION

In one embodiment, the present invention provides a memory controller for a processing system, including a command-based memory device, a system controller, and system memory. The system controller is configured to store a sequence of descriptors in the system memory corresponding to one or more memory operations accessing the command-based memory device. The memory controller is configured to read the sequence of descriptors from the system memory and implement the one or more memory operations without requiring intervention by the system controller.

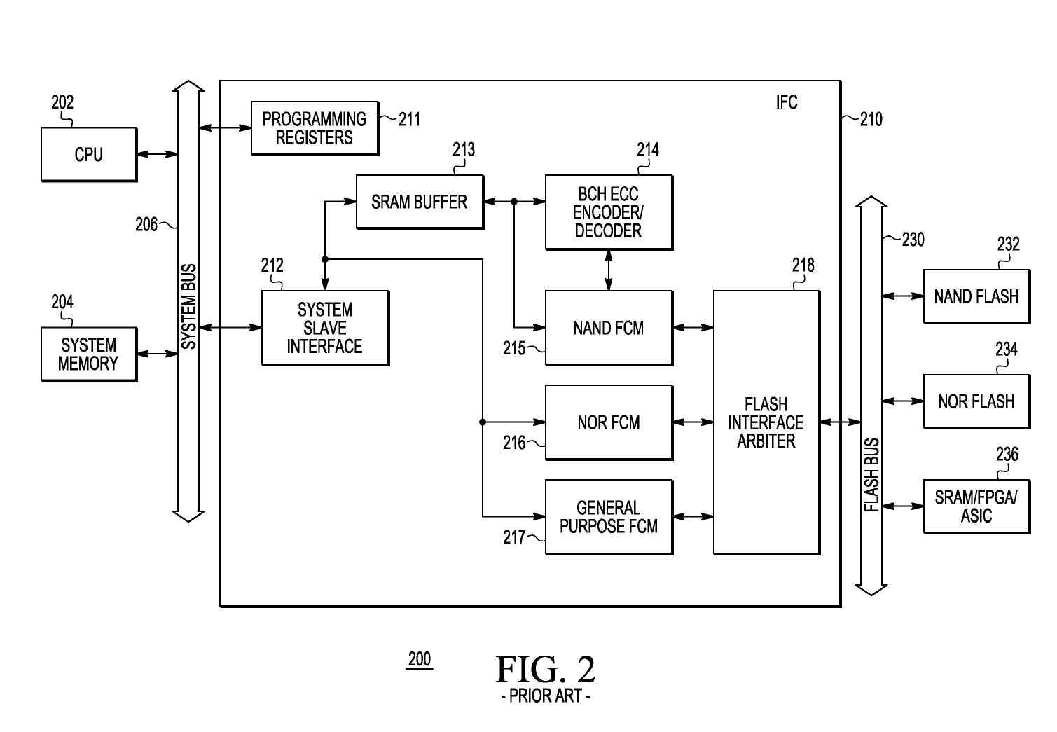

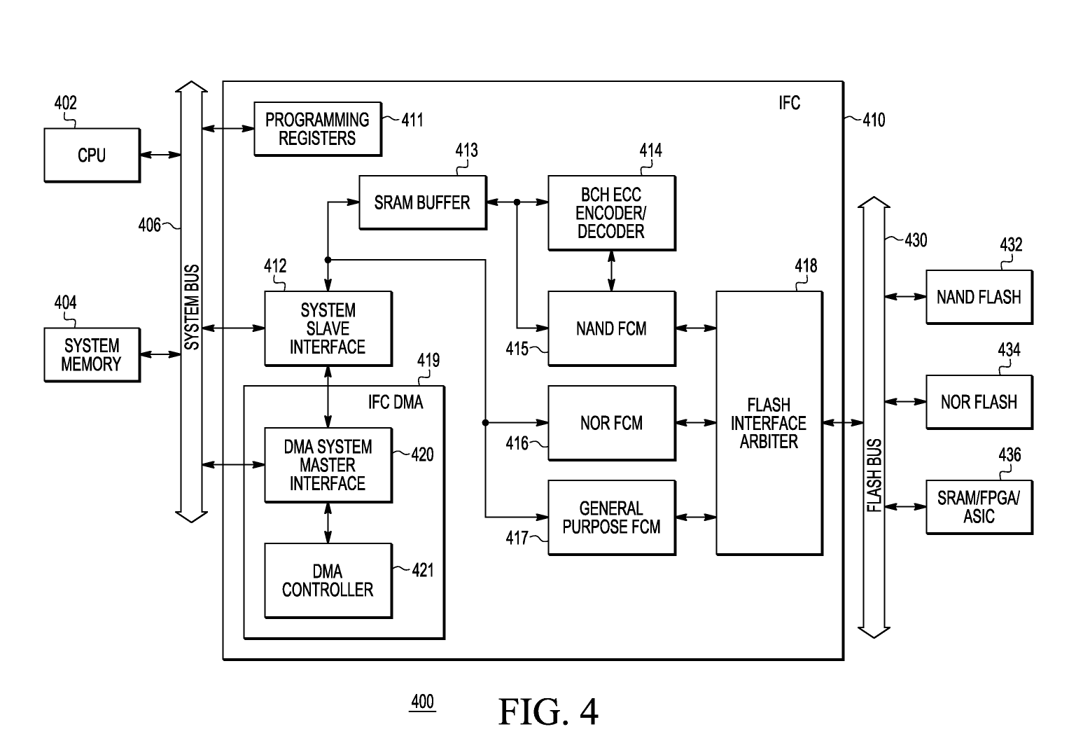

Referring now to FIG. 4, a block diagram of a processing system 400 having memory devices such as NAND flash memory device 432, NOR flash memory device 434, and SRAM, FPGA, or ASIC memory device 436, according to one embodiment of the present invention is shown. The processing system 400 is analogous to the processing system 200 of FIG. 2 with like components labeled with like labels. The processing system 400 also includes an IFC 410 that is analogous to the IFC 210 of FIG. 2, again with like sub-components labeled with like labels. Note that all of the memory devices may be, but do not have to be, conventional memory devices, including the NAND flash memory device 432, which may be, but does not have to be, identical to the conventional NAND flash memory device 100 of FIG. 2.

In this patent application, the most significant difference between the processing systems 200 and 400, in general, and between the IFCs 210 and 410, in particular, is the presence in the IFC 410 of an IFC DMA block 419, which comprises a DMA system master interface 420 and a DMA controller 421. The DMA controller 421 provides the IFC 410 with the ability to control the operations of the NAND flash memory device 432 without having to rely on the extent of CPU intervention of the conventional IFC 210 of FIG. 2.

As described in further detail below, instead of relying on real-time CPU intervention for each access of the NAND flash memory device 432, the processing system 400 is designed such that the CPU 402 will store a descriptor chain (i.e., a sequence of commands) in the system memory 404, where, after a single, initial instruction from the CPU 402, the IFC 410 is able implement the entire descriptor chain without having to interrupt the CPU 402 or otherwise require any subsequent CPU intervention until the sequence of commands has been completely executed.

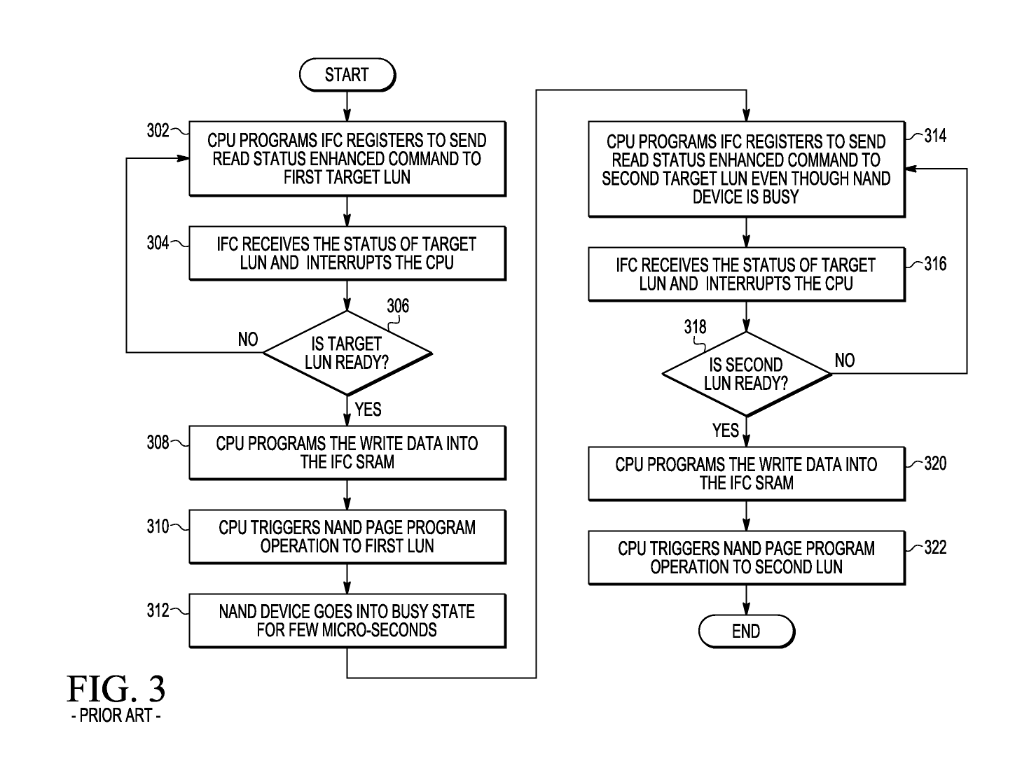

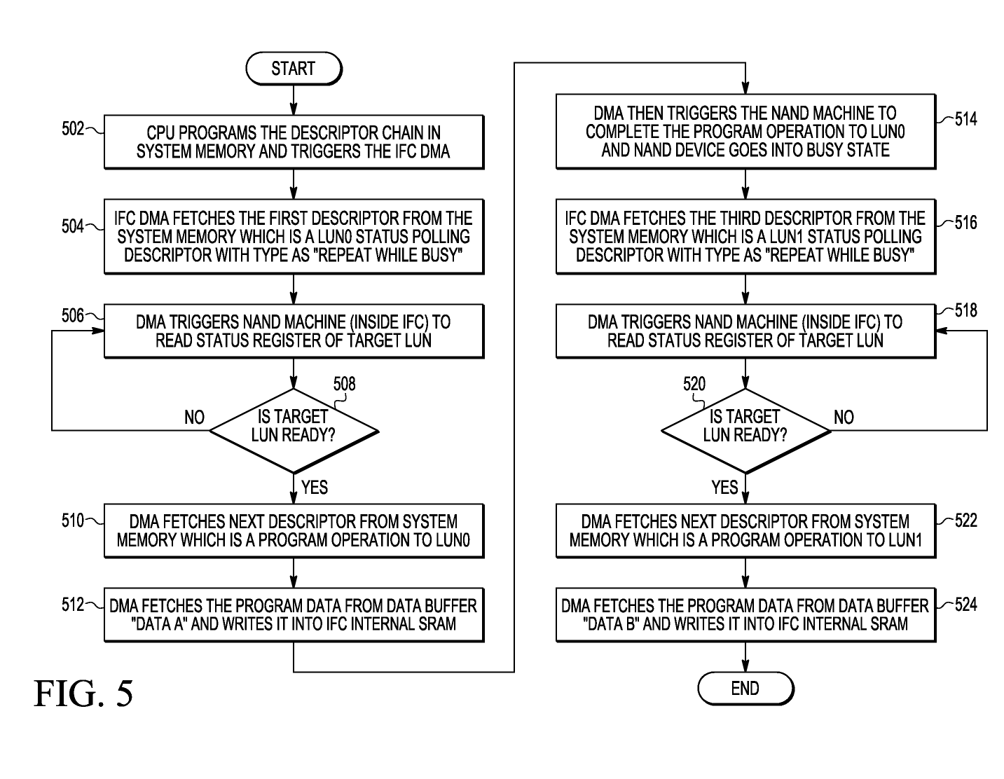

FIG. 5 is a flow chart of an exemplary sequence of operations of the processing system 400. Like the operations of FIG. 3, the exemplary sequence of operations of FIG. 5 correspond to two consecutive data-write operations to the NAND flash memory device 432. In this particular scenario, the first data-write operation is to LUN0 of the NAND flash memory device 432, and the second data-write operation is to the NAND flash memory device's LUN1.

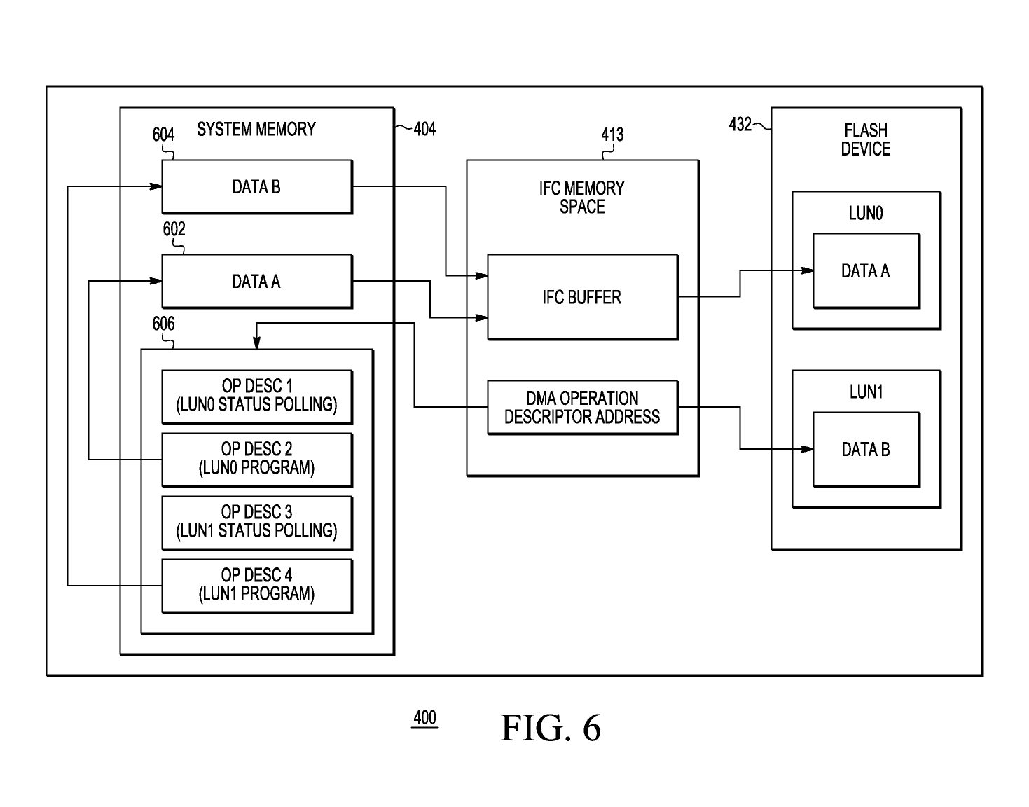

FIG. 6 shows a portion of the processing system 400 of FIG. 4 representing the sequence of operations of FIG. 5, where Data A is to be written to LUN0 of the NAND flash memory device 432, and Data B is to be written to LUN1 of the NAND flash memory device 432.

Referring now to FIG. 5, in step 502, the CPU 402 stores the descriptor chain (606 in FIG. 6) for the two write operations in the system memory 404 and triggers (e.g., commands) the IFC DMA 419 to implement the stored descriptor chain.

In step 504, the IFC DMA 419 fetches the first descriptor in the stored descriptor chain 606 from the system memory 404. The first descriptor is a status polling command for LUN0 of the NAND flash memory device 432 of the type “Repeat While Busy.” As indicated by steps 506 and 508, according to this status polling command, the IFC DMA 419 will cause the NAND FCM 415 to repeatedly transmit Read Status Enhanced commands to the NAND flash memory device 432 until the response from the NAND flash memory device 432 indicates that LUN0 is available. Note that steps 506 and 508 do not directly involve the CPU 402 in real time in any way. When LUN0 is finally available, processing continues to step 510.

In step 510, the IFC DMA 419 fetches the next (i.e., second) descriptor from the system memory 404. In this case, the second descriptor is a data-write program operation to LUN0 of the NAND flash memory device 432. As such, in step 512, the IFC DMA 419 fetches Data A from the memory location 602 of the system memory 404 and stores it into the IFC SRAM buffer 413. In step 514, the IFC DMA 419 triggers the NAND FCM 415 to implement the data-write program operation by copying Data A from the SRAM buffer 413 into LUN0 of the NAND flash memory device 432. As indicated in step 514, the NAND flash memory device 432 goes into the busy state until that data-write operation is completed.

In the meantime, in step 516, the IFC DMA 419 fetches the next (i.e., third) descriptor from the system memory 404. In this case, the third descriptor is a status polling command for LUN1 of the NAND flash memory device 432 of the type “Repeat While Busy.” Steps 518-524 for writing Data B from the system memory location 604 into LUN1 based on the third and fourth stored descriptors are analogous the previously described steps 506-512 for writing Data A into LUN0 based on the first and second stored descriptors. Here, too, as before, steps 518 and 520 do not directly involve the CPU 402 in real-time in any way.

Note that the sequence of FIG. 5 involved the CPU 402 initially storing the descriptor chain and two sets of data into the system memory 404 and then triggering the IFC DMA 419 once. Other than that, the entire sequence of operations was completed without interrupting the CPU and without any subsequent CPU intervention, no matter how long it takes for the individual NAND flash memory device operations to be completed. This reduced level of CPU intervention compared with the analogous prior art frees up CPU resources to perform other operations, including, but not limited to, writing data to and reading data from the other memory devices of processing system 400.

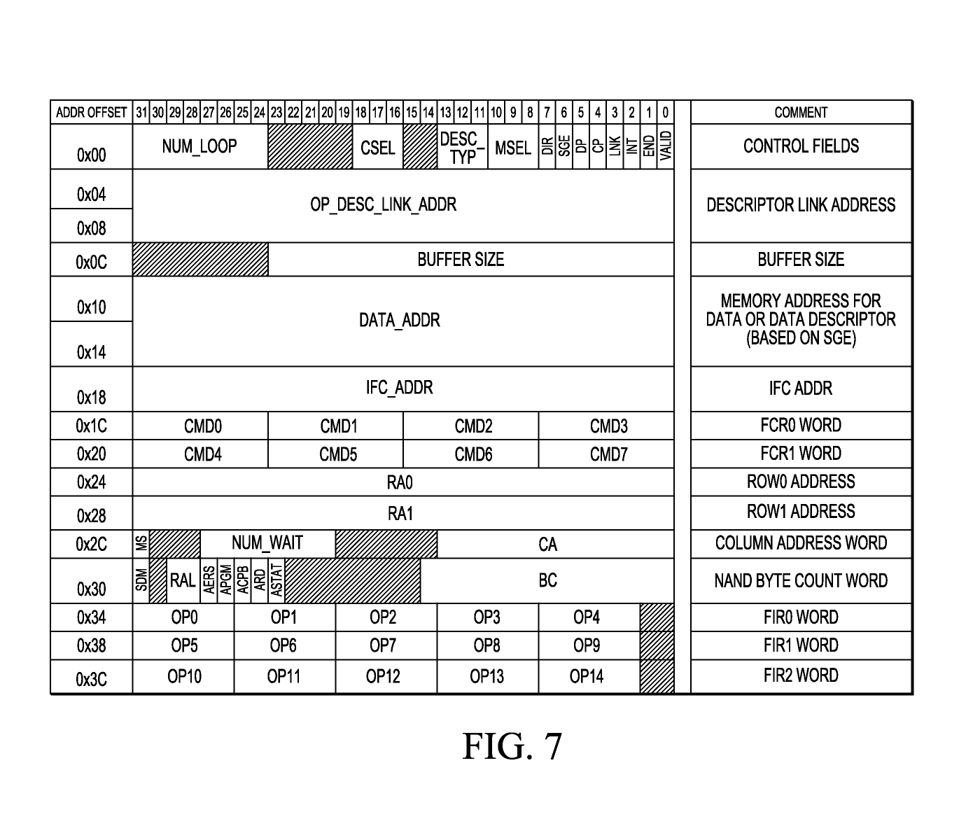

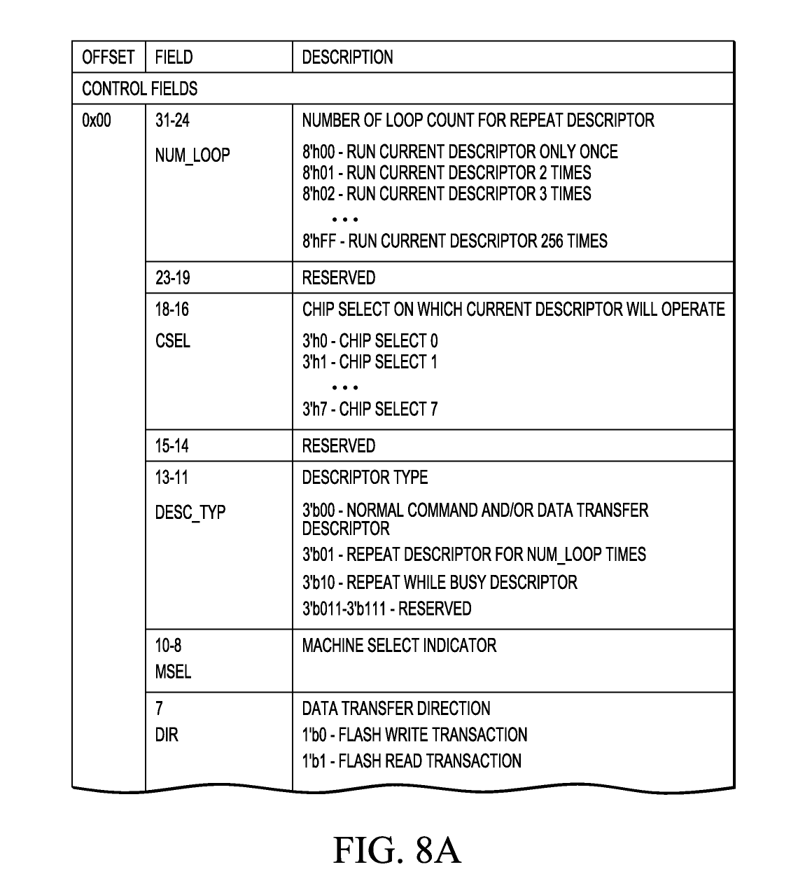

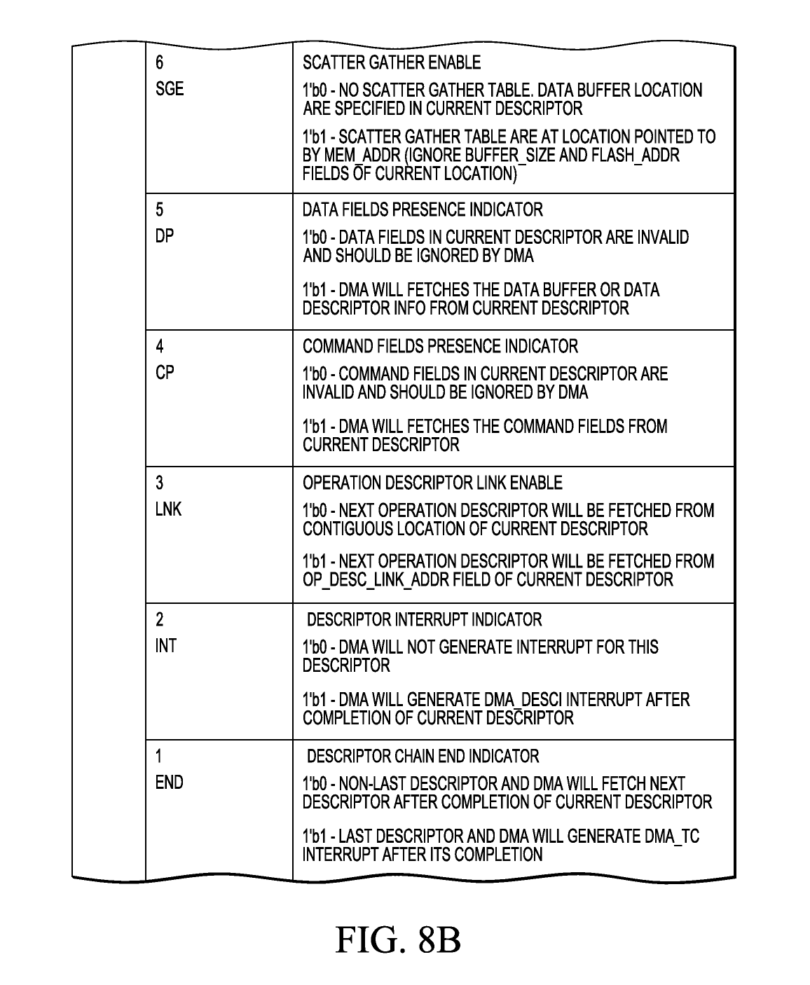

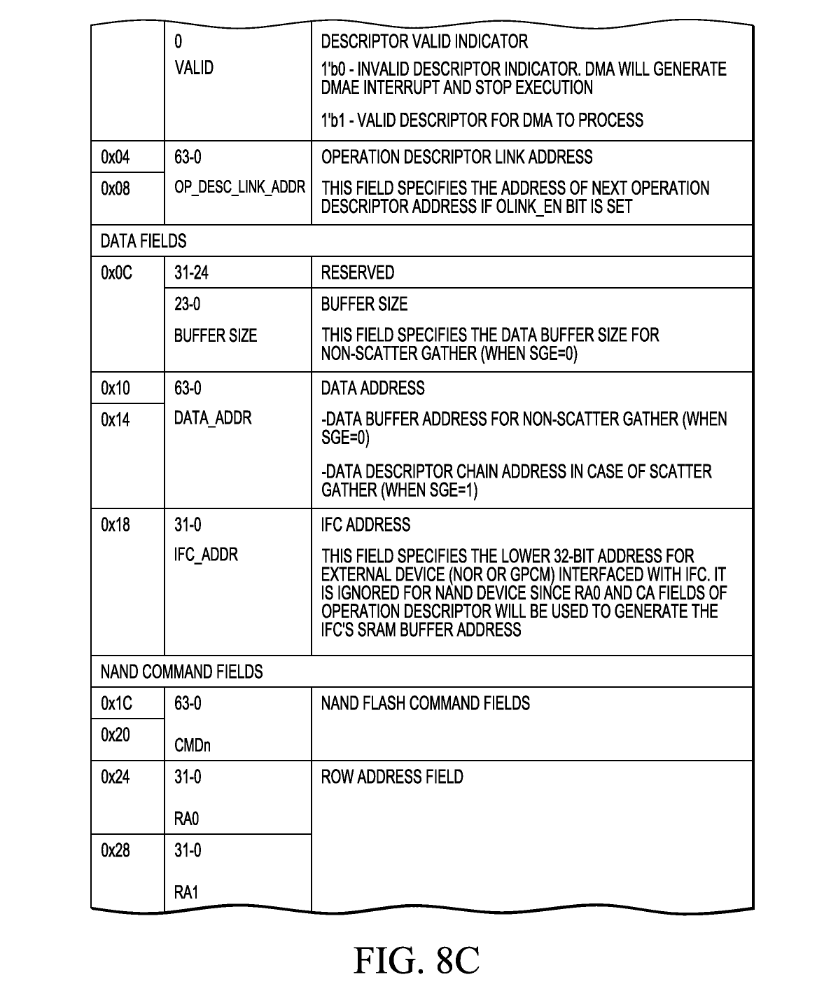

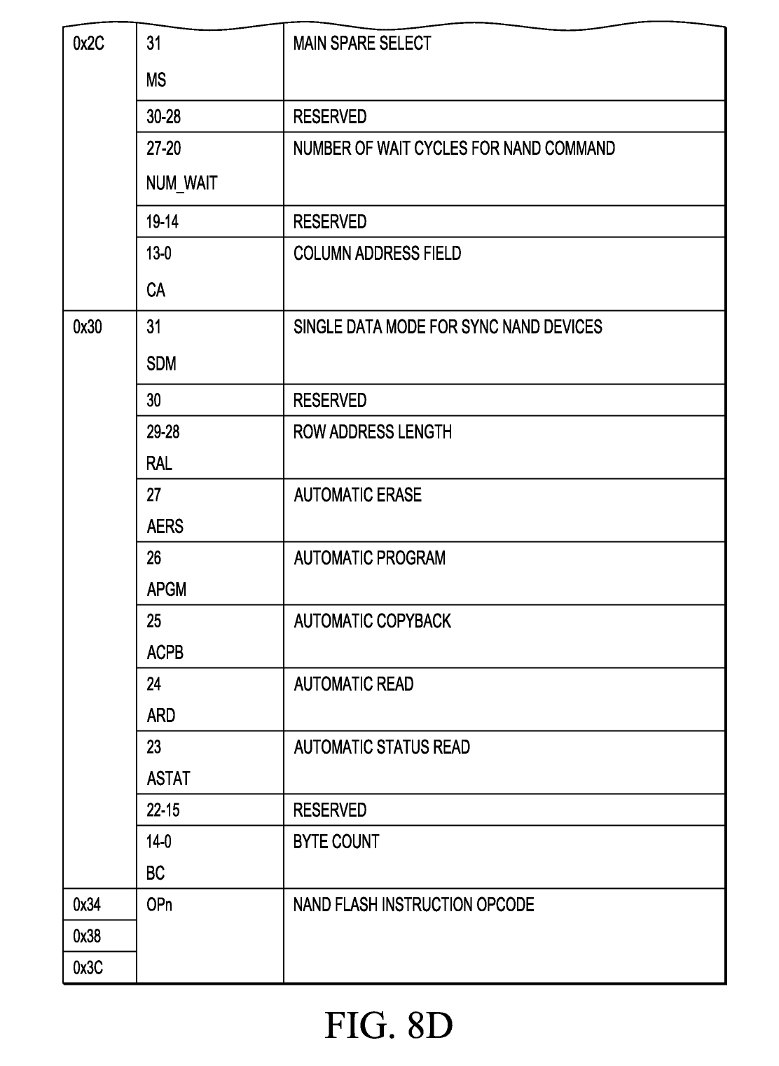

FIG. 7 shows a tabular representation of the syntax of the descriptors stored in the system memory 404 according to one possible implementation of the present invention. FIG. 8 presents a table defining the various descriptor fields shown in FIG. 7.

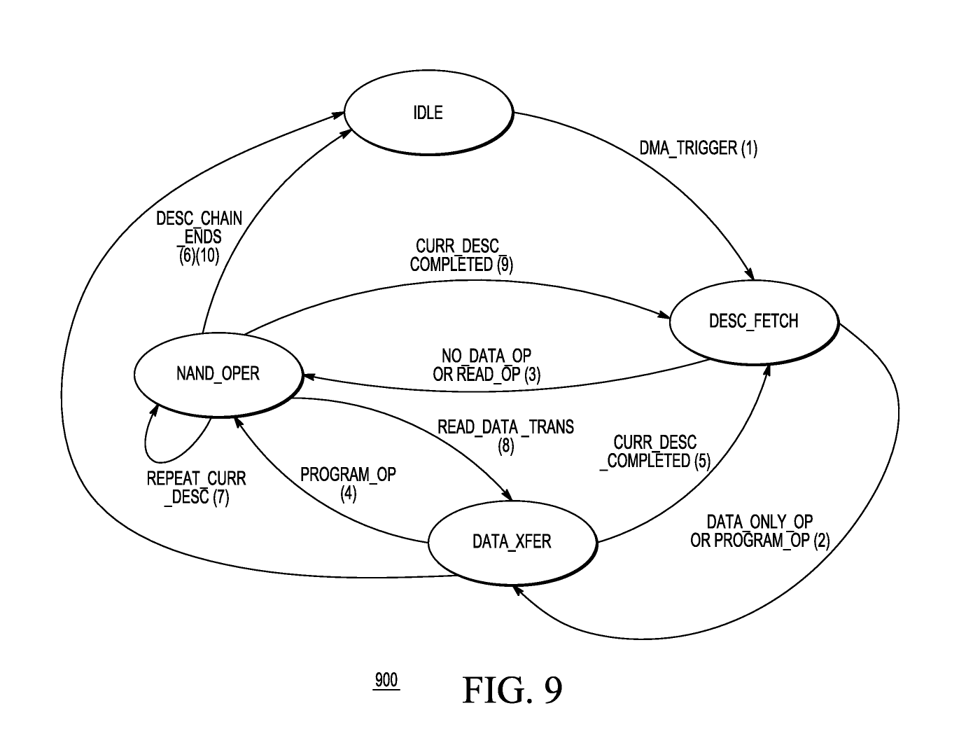

FIG. 9 shows a state diagram 900 for the operations of the DMA controller 421 of FIG. 4 according to one possible FSM (finite state machine) implementation of the present invention. The state diagram 900 has the following four states:
IDLE: DMA controller 421 idle, waiting to implement next descriptor chain;
DESC_FETCH: DMA controller 421 fetching next descriptor from system memory 404;
DATA_XFER: DMA controller 421 copying write data from system memory 404 into IFC SRAM buffer 413 or copying read data from IFC SRAM buffer 413 into system memory 404; and
NAND_OPER: DMA controller 421 waiting for NAND FCM 415 to complete NAND operation with NAND flash memory device 432.

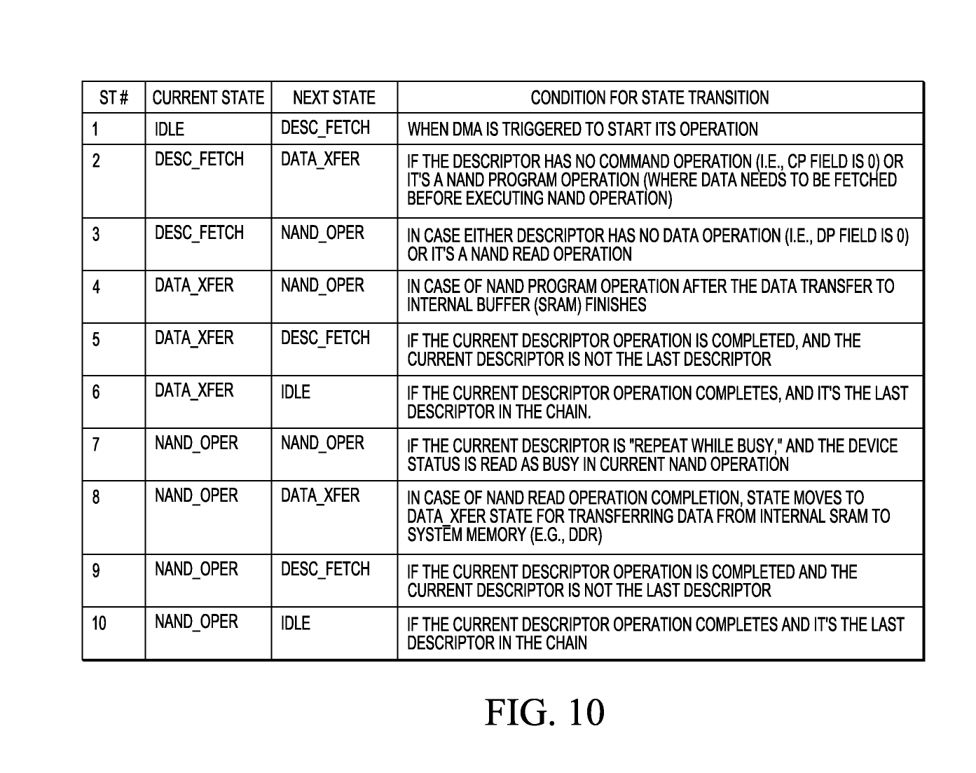

FIG. 10 presents a table containing descriptions of the ten different state transitions shown in FIG. 9.

Although the present invention has been described in the context of a processing system having a single NAND flash memory device, in general, processing systems of the present invention can have one or more NAND flash memory devices.

Although the present invention has been described in the context of providing processing systems with direct memory access functionality for NAND flash memory devices, those skilled in the art will understand that the present invention can be implemented in the context of command-based memory devices, other than NAND flash memory devices, such as SD (Secure Digital) cards, eMMC (embedded Multi-Media Controller) devices, SATA (Serial ATA) hard disks, etc.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable medium and so executed by a computer or processor, whether or not such computer or processor is explicitly shown.

It will be further understood that various changes in the details, materials, and arrangements of the parts that have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

1. A memory controller for a processing system, comprising:
a command-based memory device;
a system controller; and
system memory, wherein:
the system controller is configured to store a sequence of descriptors into the system memory corresponding to one or more memory operations accessing the command-based memory device; and
the memory controller is configured to read the sequence of descriptors from the system memory and implement the one or more memory operations without requiring intervention by the system controller.

2. The memory controller of claim 1, wherein:
the command-based memory device is a NAND flash memory device;
the memory controller is an integrated function controller configured to support memory operations for one or more NAND flash memory devices and for one or more other memory devices of the processing system; and
the system controller is a central processing unit for the processing system.

3. The memory controller of claim 2, wherein the one or more other memory devices comprise one or more memory-mapped devices.

4. The memory controller of claim 1, wherein the sequence of descriptors comprises a first descriptor type that causes the memory controller to check status of the command-based memory device one or more times without requiring further intervention by the system controller until the command-based memory device is available to handle a memory operation.

5. The memory controller of claim 4, wherein the memory controller uses a Read Status Enhanced command for each check of the status of the command-based memory device.

6. The memory controller of claim 1, wherein each descriptor in the sequence of descriptors has a common format that can be used to instruct the memory controller to perform any type of memory operation supported by the command-based memory device.

7. The memory controller of claim 1, wherein the memory controller comprises:
one or more system interfaces configured to support communication with the system controller and the system memory;
a memory interface configured to support communication with the command-based memory device;
local memory configured to store write data to be written to the command-based memory device and read data read from the command-based memory device; and
a direct memory access (DMA) controller configured to implement the sequence of descriptors fetched from the system memory.

8. The memory controller of claim 7, wherein:
the command-based memory device is a NAND flash memory device; and
the memory controller further comprises a NAND function control machine (FCM) configured to support memory operations to one or more NAND flash memory devices.

9. The memory controller of claim 8, wherein the memory controller further comprises one or more of:
a NOR FCM configured to support memory operations for one or more NOR flash memory devices; and
a general-purpose FCM configured to support memory operations of another type of memory-mapped device.

10. The invention of claim 1, wherein:
the command-based memory device is a NAND flash memory device;
the memory controller is an integrated function controller configured to support memory operations for one or more NAND flash memory devices and for one or more other memory devices of the processing system;
the system controller is a central processing unit for the processing system;
the one or more other memory devices comprise one or more memory-mapped devices;
the sequence of descriptors comprises a first descriptor type that causes the memory controller to check status of the command-based memory device one or more times without requiring further intervention by the system controller until the command-based memory device is available to handle a memory operation;
the memory controller uses a Read Status Enhanced command for each check of the status of the command-based memory device;
each descriptor in the sequence of descriptors has a common format that can be used to instruct the memory controller to perform any type of memory operation supported by the command-based memory device;
the memory controller comprises:
one or more system interfaces configured to support communication with the system controller and the system memory;
a memory interface configured to support communication with the command-based memory device;
local memory configured to store write data to be written to the command-based memory device and read data read from the command-based memory device; and
a direct memory access (DMA) controller configured to implement the sequence of descriptors fetched from the system memory;
the memory controller further comprises one or more of:
a NOR FCM configured to support memory operations for one or more NOR flash memory devices; and
a general-purpose FCM configured to support memory operations of another type of memory-mapped device.

11. A system controller for a processing system, comprising:
a command-based memory device;
a memory controller; and
system memory, wherein:
the system controller is configured to store a sequence of descriptors into the system memory corresponding to one or more memory operations accessing the command-based memory device; and
the memory controller is configured to read the sequence of descriptors from the system memory and implement the one or more memory operations without requiring intervention by the system controller.

12. The system controller of claim 11, wherein the system controller is a central processing unit.
